(19) United States
(12) Patent Application Publication
(10) Pub. No.: US 2026/0307132 A1
(43) Pub. Date: Oct. 8, 2026

(54) ELECTRODE SHEARING APPARATUS

(71) Applicant: SAMSUNG SDI CO., LTD., Yongin-si (KR)

(72) Inventors: Sung Kyun JUNG, Suwon-si (KR); Yong Seung SHIN, Suwon-si (KR); Hee Taek LIM, Suwon-si (KR); Hong Woo JEON, Suwon-si (KR)

(21) Appl. No.: 19/461,554

(22) Filed: Jan. 27, 2026

(30) Foreign Application Priority Data
Feb. 14, 2025 (KR) 10-2025-0019383

(51) Int. Cl. B21D 28/14; B21D 28/00; B21D 28/34; B21D 53/00; H01M 4/04; H01M 10/04

(52) U.S. Cl. CPC B21D 28/14; B21D 28/002; B21D 28/34; B21D 53/00; H01M 4/04; H01M 10/04

(57) ABSTRACT

An electrode shearing apparatus includes a die configured to support an electrode, a punch configured to cut, by a shearing force, a part of the electrode that is not supported by the die, a first die pusher configured to press the die in a direction opposite to a direction in which a clearance between the die and the punch is increased, and a first punch pusher configured to press the punch in the direction opposite to the direction in which the clearance between the die and the punch is increased.

### CROSS-REFERENCE TO RELATED APPLICATION

The present application claims priority to and the benefit of Korean Patent Application No. 10-2025-0019383, filed on Feb. 14, 2025 in the Korean Intellectual Property Office, the entire disclosure of which is incorporated herein by reference.

### BACKGROUND

### 1. Field

Aspects of embodiments of the present disclosure relate to an electrode shearing apparatus.

### 2. DISCUSSION OF RELATED ART

In general, a secondary battery includes an electrode assembly that includes a positive electrode and a negative electrode, that is, a pair of secondary battery electrodes, and a separator interposed between the secondary battery electrodes. Each of the secondary battery electrodes includes an electrode plate including a thin metal foil and an electrode active material applied and cured on one side surface or both, or opposite, side surfaces of the electrode plate.

In the secondary battery electrode, a region where the electrode active material is not applied is referred to as an uncoated portion, and a region where the electrode active material is applied is referred to as a coated portion. A process of partially cutting the uncoated portion to form tabs on the secondary battery electrode and remove an unnecessary portion therefrom is referred to as a notching process of the secondary battery electrode.

In order to perform the notching process of the secondary battery electrode, a shearing method in which the electrode is pressed and cut by a punch (herein referred to as “press notching”) may be applied. During the press notching process, a force is applied between the electrode, a die, and the punch, which may change a clearance between the die and the punch. As a result, the die and the punch may be damaged. In addition, the quality of the press notching operation may deteriorate, and a defect rate of the electrode may increase.

The aforementioned information disclosed in this background section is provided to facilitate understanding of the background technology of the present disclosure and may contain information that does not constitute the related art.

### SUMMARY

According to an aspect of embodiments of the present disclosure, an electrode shearing apparatus capable of maintaining a constant (constant or substantially constant) clearance between a die and a punch is provided.

However, aspects and technical problems to be solved by the present disclosure are not limited to the aspects and problems to be solved described above, and other aspects and problems to be solved that are not described may be clearly understood by those skilled in the art from the description of the invention described below.

According to one or more embodiments of the present disclosure, an electrode shearing apparatus includes a die configured to support an electrode, a punch configured to cut, by a shearing force, a part of the electrode that is not supported by the die, a first die pusher configured to press the die in a direction opposite to a direction in which a clearance between the die and the punch is increased, and a first punch pusher configured to press the punch in the direction opposite to the direction in which the clearance between the die and the punch is increased.

The punch may include an edge configured to cut the electrode, and a guide rail protruding further than the edge in a direction toward the die.

The die may include a punch through-hole into which the edge is inserted when the electrode is cut, and a guide groove into which the guide rail is inserted, and at least a part of the guide rail may always be inserted into the guide groove while the punch reciprocates with respect to the die.

The guide rail and the guide groove may be positioned so as not to overlap the electrode.

The first die pusher may be positioned to overlap the electrode, and the first punch pusher may be positioned so as not to overlap the electrode.

The electrode shearing apparatus may further include a die plate into which the die is inserted and on which the first die pusher is coupled and supported.

The first die pusher may include an elastic member configured to elastically press the die.

The first die pusher may further include a die pusher housing coupled to the die plate, a pusher pin having a side coupled to the die pusher housing and extending toward the die, and a die contact portion coupled to the pusher pin and in contact with the die, and the pusher pin may be inserted into the elastic member and the elastic member may include a side end portion supported by the pusher pin and another side end portion in elastic contact with the die contact portion to elastically press the die contact portion toward the die.

The first die pusher may further include a die contact portion inserted into the die plate and in contact with the die, a pusher pin inserted into the die plate and having a side end portion coupled to the die contact portion, and a plug inserted into and fixed to the die plate and spaced apart from another side end portion of the pusher pin, and the elastic member may be inserted into the die plate and may include a side end portion supported by the plug and another side end portion in elastic contact with the pusher pin to elastically press the pusher pin and the die contact portion toward the die.

The first die pusher may include a die contact portion in contact with the die, and a die pusher actuator configured to provide a driving force to press the die contact portion toward the die, and the die pusher actuator may include one selected from the group consisting of an electric motor, a pneumatic cylinder, and a hydraulic cylinder.

The first punch pusher may include a punch contact portion in contact with the punch, and an elastic member configured to elastically press the punch contact portion toward the punch.

The punch contact portion may always be in contact with the punch while the punch reciprocates with respect to the die.

The punch contact portion may include polytetrafluoroethylene (PTFE).

The punch contact portion may include a roller that rotates by contact with the punch.

The first punch pusher may include a punch contact portion in contact with the punch, and a punch pusher actuator configured to provide a driving force to press the punch contact portion toward the punch, and the punch pusher actuator may include one selected from the group consisting of an electric motor, a pneumatic cylinder, and a hydraulic cylinder.

The electrode shearing apparatus may further include a die plate into which the die is inserted and on which the first punch pusher is coupled and supported.

A pressing direction of the first die pusher and a pressing direction of the first punch pusher may be opposite to each other.

The first die pusher may press the die in a direction parallel to a width direction of the electrode, and the first punch pusher may press the punch in the direction parallel to the width direction of the electrode.

The electrode shearing apparatus may further include a second die pusher configured to press the die in a direction parallel to a length direction of the electrode.

The electrode shearing apparatus may further include a second punch pusher configured to press the punch in the direction parallel to the length direction of the electrode and opposite to the direction in which the second die pusher presses the die.

### BRIEF DESCRIPTION OF THE DRAWINGS

The above and other aspects, objects, features, and advantages of the present disclosure will become more apparent to those of ordinary skill in the art by describing some embodiments thereof in further detail with reference to the accompanying drawings, in which:

FIG. 1 is a cross-sectional view of an electrode shearing apparatus according to an embodiment of the present disclosure;

FIG. 2 is a perspective view illustrating a die plate, a die, a punch, a first die pusher, and a first punch pusher of the electrode shearing apparatus according to an embodiment of the present disclosure;

FIG. 3 is an exploded perspective view of FIG. 2, as viewed from above;

FIG. 4 is an exploded perspective view of FIG. 2, as viewed from below;

FIG. 5 is a plan view of components of FIG. 2;

FIG. 6 is a cross-sectional view of the first punch pusher of FIG. 5, taken along the line A-A;

FIG. 7 is a cross-sectional view illustrating another example of the first punch pusher of FIG. 6;

FIG. 8 is a cross-sectional view of the first die pusher of FIG. 5, taken along the line B-B;

FIG. 9 is a plan view illustrating a die plate, a die, a punch, a first die pusher, and a first punch pusher of an electrode shearing apparatus according to another embodiment of the present disclosure;

FIG. 10 is a plan view illustrating a die plate, a die, a punch, a first die pusher, a second die pusher, a first punch pusher, and a second punch pusher of an electrode shearing apparatus according to another embodiment of the present disclosure;

FIG. 11 is a perspective view illustrating a die plate, a die, a punch, a first die pusher, and a first punch pusher of an electrode shearing apparatus according to another embodiment of the present disclosure;

FIG. 12 is an exploded perspective view of the die plate, the die, and the punch among components of FIG. 11, as viewed from above;

FIG. 13 is an exploded perspective view of the die plate, the die, and the punch among components of FIG. 11, as viewed from below;

FIG. 14 is a plan view of components of FIG. 11; and

FIG. 15 is a cross-sectional view of the first die pusher of FIG. 14, taken along the line C-C.

### DETAILED DESCRIPTION

Herein, some embodiments of the present disclosure will be described in further detail with reference to the accompanying drawings. The terms or words used in this specification and claims are not to be construed as being limited to the usual or dictionary meaning and are to be interpreted as having meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not necessarily represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer, or one or more intervening elements or layers may also be present. When an element or layer is referred to as being “directly on,” “directly connected to,” or “directly coupled to” another element or layer, there are no intervening elements or layers present. For example, when a first element is described as being "coupled" or "connected" to a second element, the first element may be directly coupled or connected to the second element, or the first element may be indirectly coupled or connected to the second element via one or more intervening elements.

In the figures, dimensions of the various elements, layers, etc. may be exaggerated for clarity of illustration. The same reference numerals may designate the same or like elements. As used herein, the term “and/or” includes any and all combinations of one or more of the associated listed items. Further, the use of "may" when describing embodiments of the present disclosure relates to "one or more embodiments of the present disclosure." Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or "over" the other elements or features. Thus, the term “below” may encompass both an orientation of above and below. The device may be otherwise oriented (e.g., rotated 90 degrees or at other orientations), and the spatially relative descriptors used herein are to be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms "includes," "including," “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of "1.0 to 10.0" is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the "above (or below)" or "on (or under)" a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or "connected" to another element, the elements may be directly “coupled,” “linked,” or "connected" to each other, or one or more intervening elements may be present therebetween, through which the element may be “coupled,” “linked,” or “connected” to another element. In addition, when a part is referred to as being "electrically coupled" to another part, the part may be directly electrically connected to another part, or one or more intervening parts may be present therebetween such that the part and the another part are indirectly electrically connected to each other.

Throughout the specification, when "A and/or B" is stated, it means A, B, or A and B, unless otherwise stated. That is, “and/or” includes any or all combinations of a plurality of items enumerated. When "C to D" is stated, it means C or more and D or less, unless otherwise specified.

The terms used in the present specification are for describing embodiments of the present disclosure and are not intended to limit the present disclosure.

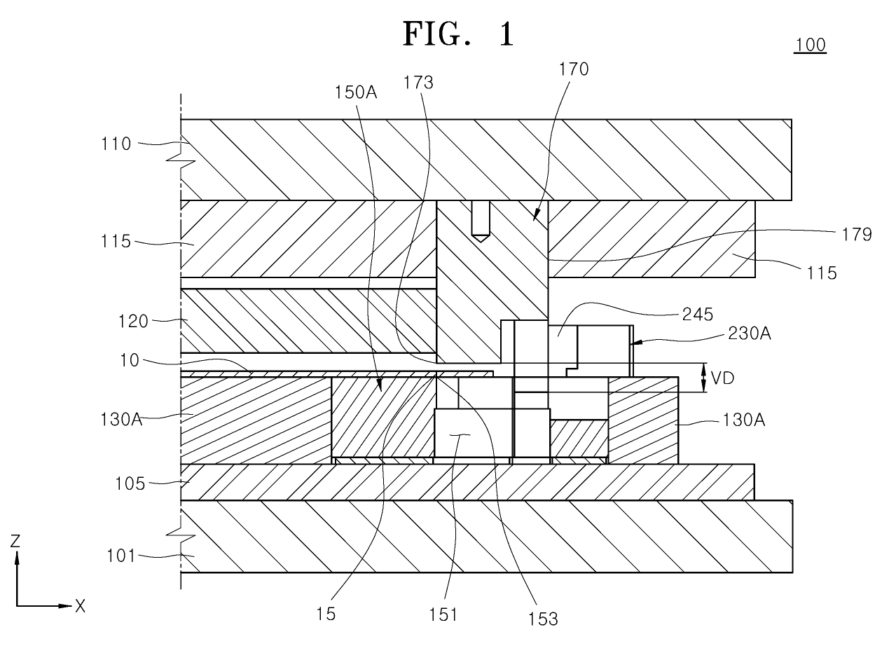

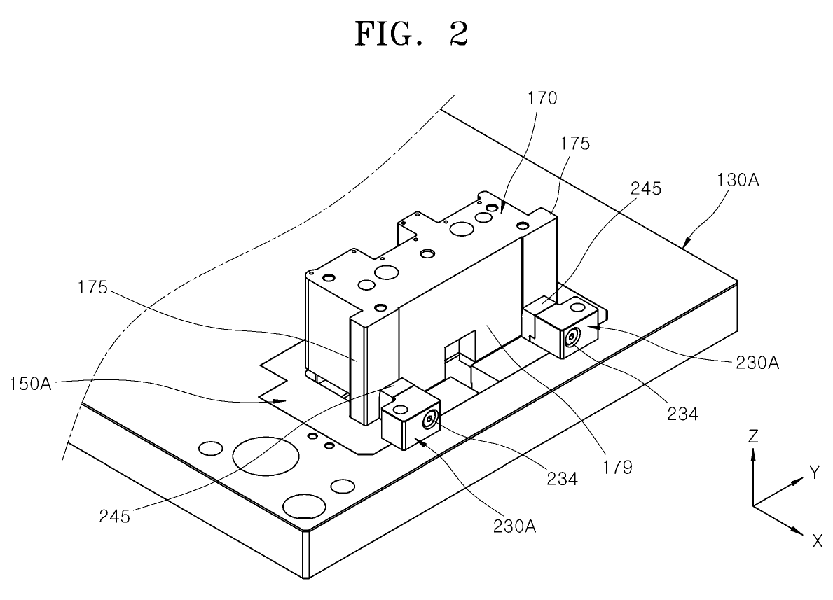

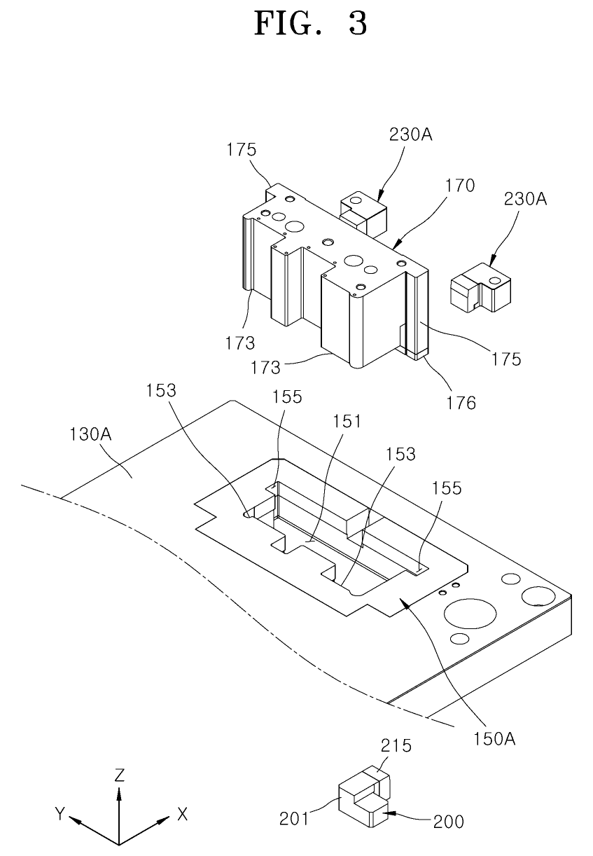

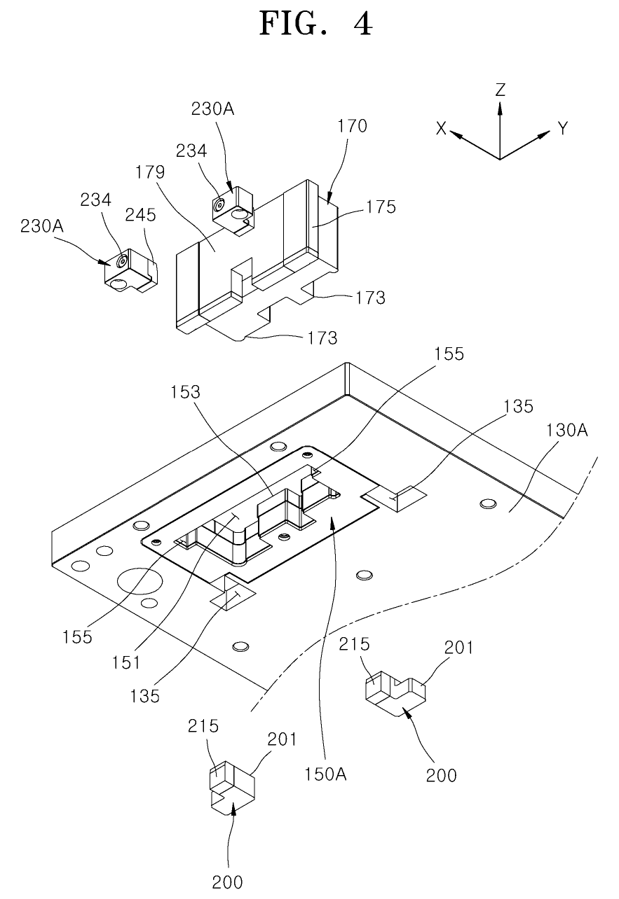

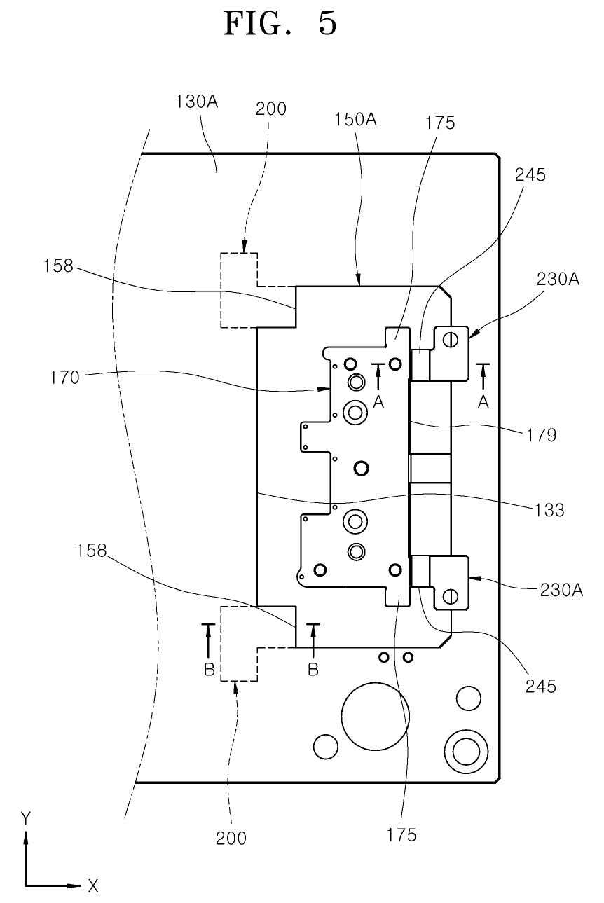

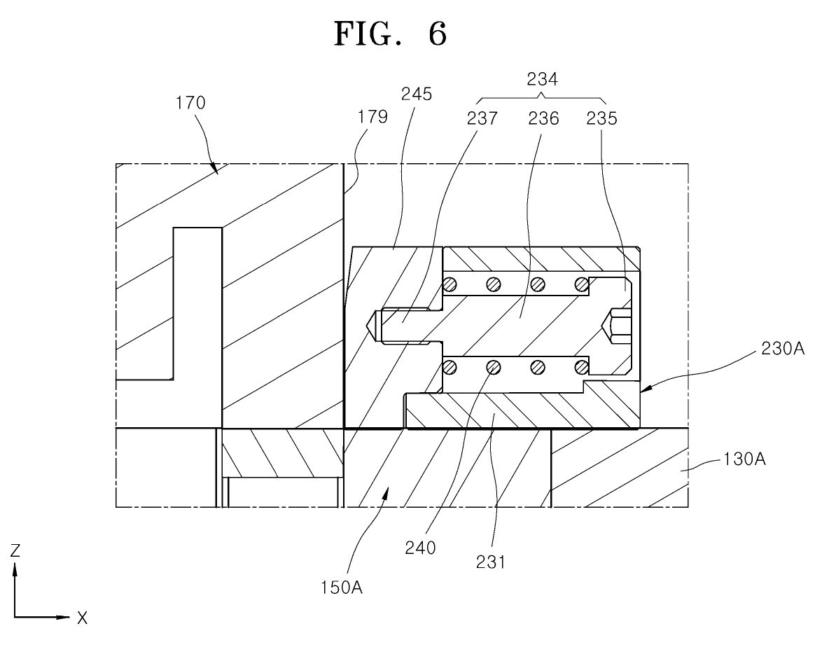

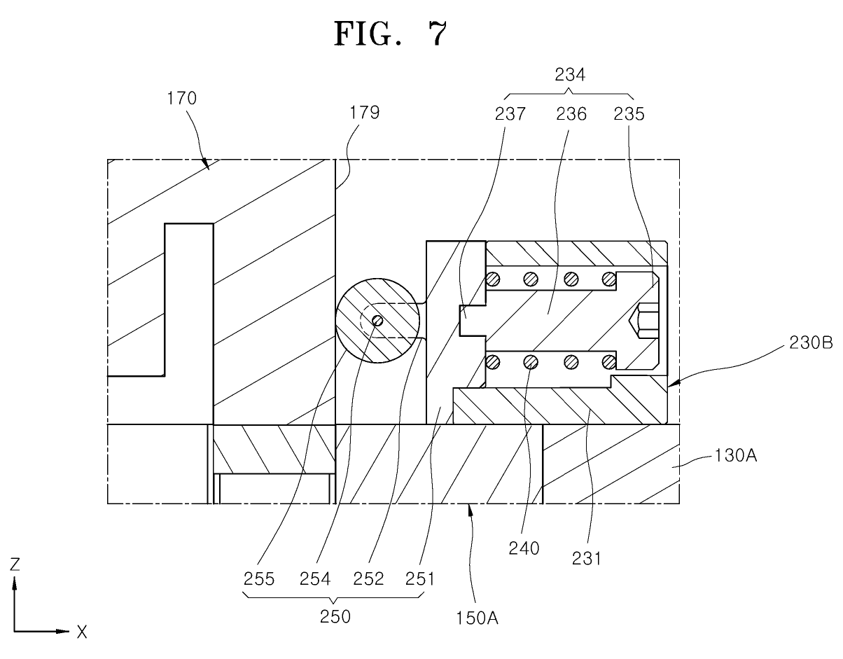

FIG. 1 is a cross-sectional view of an electrode shearing apparatus according to an embodiment of the present disclosure; FIG. 2 is a perspective view illustrating a die plate, a die, a punch, a first die pusher, and a first punch pusher of the electrode shearing apparatus according to an embodiment of the present disclosure; FIG. 3 is an exploded perspective view of FIG. 2, as viewed from above; FIG. 4 is an exploded perspective view of FIG. 2, as viewed from below; FIG. 5 is a plan view of components of FIGS. 2; 6 is a cross-sectional view of the first punch pusher of FIG. 5, taken along the line A-A; FIG. 7 is a cross-sectional view illustrating another example of the first punch pusher of FIGS. 6; and 8 is a cross-sectional view of the first die pusher of FIG. 5, taken along the line B-B.

Referring to FIGS. 1 to 8, an electrode shearing apparatus 100 according to an embodiment of the present disclosure includes a die 150A, a punch 170, a first die pusher 200, and a first punch pusher 230A. The die 150A supports an electrode 10 of a secondary battery.

The electrode 10 may include, for example, an electrode plate including a thin metal foil and an electrode active material that is applied to and cured on a side surface or both, or opposite, side surfaces of the electrode plate. While the electrode 10 continuously proceeds through a roll-to-roll process, the electrode 10 may pass through the electrode shearing apparatus 100 and may be sheared, e.g., notched, along a cutting line 15.

The electrode 10 extends in a direction parallel to a traveling direction. Herein, a direction parallel to a width direction of the electrode 10 is referred to as a first direction, a direction perpendicular to the first direction and parallel to a length direction of the electrode 10 is referred to as a second direction, and a direction perpendicular to both the first and second directions is referred to as a third direction. In the drawings, an X-axis direction may indicate the first direction, a Y-axis direction may indicate the second direction, and a Z-axis direction may indicate the third direction.

The punch 170 cuts, by a shearing force, a part of the electrode 10 that is not supported by the die 150A.

The electrode shearing apparatus 100 may further include a die holder 101, a die support plate 105, a die plate 130A, a punch holder 110, a punch fixing plate 115, and a stripper 120.

The die 150A may be mounted on the die plate 130A. The die plate 130A may include a die mounting through-hole 133 into which the die 150A is inserted and mounted. The die support plate 105 may support the die plate 130A and the die 150A from below in the third direction. The die holder 101 may support the die support plate 105 from below in the third direction.

The punch holder 110 may support the punch 170 from above in the third direction. The punch fixing plate 115 restrains the punch 170 from being displaced or deformed in the first or second direction while the punch 170 shears the electrode 10. The punch fixing plate 115 may be fixed to and supported by the punch holder 110. The punch 170 may pass through the punch fixing plate 115 to be coupled to the punch holder 110.

The stripper 120 may press the electrode 10 against the die 150A to bring the electrode 10 into contact (e.g., close contact) with the die 150A when the punch 170 moves toward the die 150A to shear the electrode 10 supported by the die 150A. The stripper 120 may be supported by the punch holder 110.

The punch 170 may include an edge 173 configured to cut the electrode 10. The edge 173 of the punch 170 may be formed at a lower end portion of the punch 170 in the third direction.

The die 150A may include a punch through-hole 151 and an edge 153. The edge 173 of the punch 170 may be inserted into the punch through-hole 151 when the electrode 10 is cut. The electrode 10 may be cut along the cutting line 15, and a scrap (not shown) separated from the electrode 10 may be discharged to the outside of the electrode shearing apparatus 100 through the punch through-hole 151.

The edge 153 of the die 150A may be formed at a position spaced apart from the edge 173 of the punch 170 by a clearance (e.g., a predetermined clearance) in the first and second directions. The edge 153 of the die 150A may be formed at an upper end portion of the die 150A in the third direction.

While the electrode 10 is supported on upper surfaces of the die plate 130A and the die 150A and proceeds in the second direction, the electrode 10 may be sheared as the punch holder 110 and the punch 170, the punch fixing plate 115, and the stripper 120 supported by the punch holder 110 reciprocate in the third direction with respect to the die 150A.

For example, the punch holder 110, the punch 170, the punch fixing plate 115, and the stripper 120 may reciprocate up and down above the die holder 101 in a direction toward the die holder 101 and in an opposite direction.

The punch 170 may include a guide rail 175 protruding further in a direction toward the die 150A than the edge 173. A pair of guide rails 175 may be provided. The pair of guide rails 175 may be respectively located at both, or opposite, side end portions of the punch 170 in the second direction and may protrude in directions opposite to each other in the second direction.

The pair of guide rails 175 may extend in the third direction. The pair of guide rails 175 may protrude further than the edge 173 of the punch 170 by a length (e.g., a predetermined length) VD in the direction toward the die 150A. Here, the direction toward the die 150A may be, for example, the third direction, that is, a negative (-) Z-axis direction.

The die 150A may further include a guide groove 155 into which the guide rail 175 is inserted. A pair of guide grooves 155 may be provided in one-to-one correspondence with the guide rails 175. The pair of guide grooves 155 may be a part or region of the punch through-hole 151.

In an embodiment, while the punch 170 reciprocates in the third direction with respect to the die 150A, at least a part of each guide rail 175 may always be inserted into the corresponding guide groove 155. In this case, as shown in FIG. 1, the guide rails 175 and the guide grooves 155 may be positioned so as not to overlap the electrode 10 in the third direction.

As shown in FIG. 1, since the lower end portion of the guide rail 175 protrudes further toward the die holder 101 than the edge 173 of the punch 170, even when the edge 173 of the punch 170 is positioned higher than the upper surface of the die 150A during the reciprocating movement, that is, a vertical movement of the punch 170, the lower end portion of the guide rail 175 may be inserted into the guide groove 155. When the punch 170 reciprocates in the third direction with respect to the die 150A, the guide rail 175 may slide in the third direction while remaining in contact with an inner surface of the guide groove 155.

The first die pusher 200 presses the die 150A in a direction opposite to a direction in which a clearance between the die 150A and the punch 170 is increased. The first punch pusher 230A presses the punch 170 in the direction opposite to the direction in which the clearance between the die 150A and the punch 170 is increased.

The first die pusher 200 presses the die 150A in a direction parallel to the width direction of the electrode 10, and the first punch pusher 230A may also press the punch 170 in the direction parallel to the width direction of the electrode 10. For example, the direction parallel to the width direction of the electrode 10 may be the first direction.

The pressing direction of the first die pusher 200 and the pressing direction of the first punch pusher 230A may be opposite to each other. For example, the pressing direction of the first die pusher 200 may be a positive (+) X-axis direction, and the pressing direction of the first punch pusher 230A may be a negative (-) X-axis direction.

A plurality of first die pushers 200 may be provided. The plurality of first die pushers 200 may be disposed to be spaced apart from each other in the second direction. The die plate 130A may further include a plurality of first die pusher mounting through-holes 135 into which the plurality of first die pushers 200 are inserted and mounted. The first die pusher mounting through-hole 135 may communicate with the die mounting through-hole 133.

In an embodiment, each of the first die pushers 200 may include a die pusher housing 201, a pusher pin 204, a die contact portion 215, and an elastic member 210. The die pusher housing 201 may be inserted into the first die pusher mounting through-hole 135 and may be coupled to and fixed to the die plate 130A.

The pusher pin 204 may pass through an inner space of the die pusher housing 201 and protrude toward the die 150A. The pusher pin 204 may include a head portion 205 provided at a side, an end portion 207 provided at another side, and a body portion 206 provided between the head portion 205 and the end portion 207. The head portion 205 may be coupled to and fixed to the die pusher housing 201. The end portion 207 may pass through the inner space of the die pusher housing 201 and protrude toward the die 150A.

The die contact portion 215 may be coupled to the end portion 207 of the pusher pin 204 and in contact with the die 150A. The die contact portion 215 may be located outside the die pusher housing 201. The die 150A may include a first die pusher pressing surface 158 that is in contact with the die contact portion 215.

The elastic member 210 elastically presses the die 150A. In an embodiment, the elastic member 210 may be a coil spring into which the body portion 206 of the pusher pin 204 is inserted. The elastic member 210 may include a side end portion supported by the head portion 205 of the pusher pin 204 and another side end portion in elastic contact with the die contact portion 215 to elastically press the die contact portion 215 toward the die 150A.

In an embodiment, a plurality of first punch pushers 230A may be provided. The plurality of first punch pushers 230A may be disposed to be spaced apart from each other in the second direction. Each of the first punch pushers 230A may include a punch pusher housing 231, a pusher pin 234, a punch contact portion 245, and an elastic member 240. The punch pusher housing 231 may be supported on the upper surface of the die plate 130A or the upper surface of the die 150A. In an embodiment, the punch pusher housing 231 may be coupled to the upper surface of the die plate 130A. In an embodiment, the punch pusher housing 231 may be coupled to the upper surface of the die 150A.

The pusher pin 234 may pass through an inner space of the punch pusher housing 231 and may protrude toward the punch 170. The pusher pin 234 may include a head portion 235 provided at a side, an end portion 237 provided at another side, and a body portion 236 provided between the head portion 235 and the end portion 237. The head portion 235 may be coupled to and fixed to the punch pusher housing 231. The end portion 237 may pass through the inner space of the punch pusher housing 231 and protrude toward the punch 170.

The punch contact portion 245 may be coupled to the end portion 237 of the pusher pin 234 and in contact with the punch 170. The punch contact portion 245 may be located outside the punch pusher housing 231. The punch 170 may include a contact surface 179 that is in contact with the punch contact portion 245. The contact surface 179 may be a side surface of the punch 170 opposite to a side surface on which the edge 173 is formed in the first direction.

The elastic member 240 elastically presses the punch contact portion 245 toward the punch 170. In an embodiment, the elastic member 240 may be a coil spring into which the body portion 236 of the pusher pin 234 is inserted. The elastic member 240 may include a side end portion supported by the head portion 235 of the pusher pin 234 and another side end portion in contact (e.g., close contact) with the punch contact portion 245 to elastically press the punch contact portion 245 toward the punch 170.

In an embodiment, while the punch 170 reciprocates in the third direction with respect to the die 150A, the punch contact portion 245 may always be in contact with the contact surface 179 of the punch 170. In an embodiment, the punch contact portion 245 may include polytetrafluoroethylene (PTFE) such that friction between the contact surface 179 and the punch contact portion 245 is reduced when the punch 170 moves up and down.

In an embodiment, for example, the entire portion of the punch contact portion 245 may be made of PTFE. In an embodiment, the punch contact portion 245 may include a friction-reducing coating layer made of PTFE on a side thereof that is in contact with the contact surface 179.

In an embodiment, a first punch pusher 230B illustrated in FIG. 7 may be provided in the electrode shearing apparatus 100 instead of the first punch pusher 230A illustrated in FIGS. 2 to 6. The first punch pusher 230B illustrated in FIG. 7 may include a punch pusher housing 231, a pusher pin 234, a punch contact portion 250, and an elastic member 240. The punch pusher housing 231, the pusher pin 234, and the elastic member 240 may be the same as those illustrated in FIGS. 2 to 6 and are denoted by the same reference numerals, and redundant descriptions thereof may be omitted.

In an embodiment, the punch contact portion 250 may include a support 251, a roller bracket 252, a roller shaft 254, and a roller 255. The support 251 may be coupled to the end portion 237 of the pusher pin 234 outside the punch pusher housing 231. In an embodiment, the roller 255 may always be in contact with the contact surface 179 of the punch 170 and may rotate as the punch 170 reciprocates in the third direction.

The roller shaft 254 may extend through the center of the roller 255. The roller bracket 252 may connect the support 251 and the roller shaft 254 and may rotatably support the roller 255.

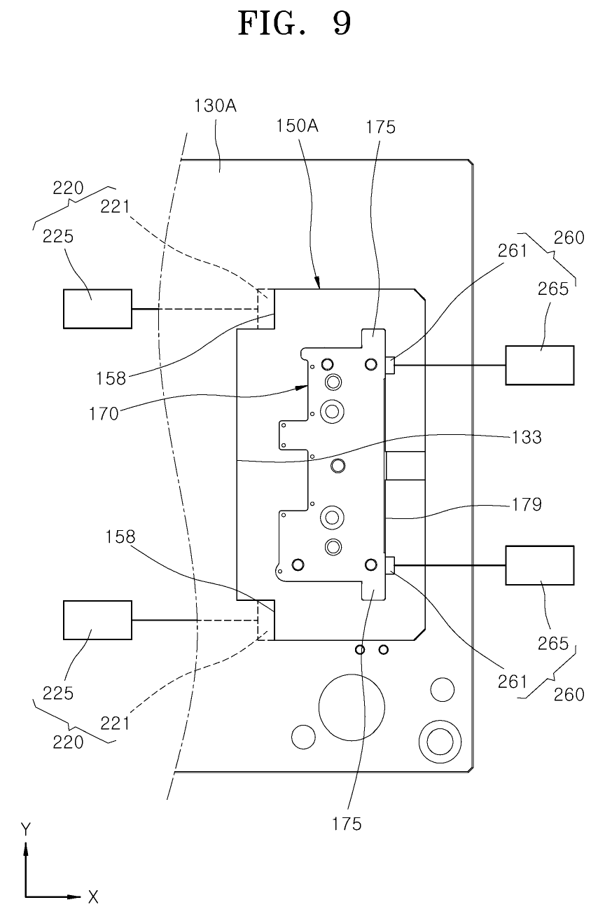

FIG. 9 is a plan view illustrating a die plate, a die, a punch, a first die pusher, and a first punch pusher of an electrode shearing apparatus according to another embodiment of the present disclosure.

Referring to FIGS. 1 to 5 and 9, the electrode shearing apparatus according to another embodiment of the present disclosure may include a die 150A, a punch 170, a die plate 130A, a plurality of first die pushers 220, and a plurality of first punch pushers 260, as in the electrode shearing apparatus 100 according to the previously described embodiment of the present disclosure.

Since the die 150A, the punch 170, and the die plate 130A may be the same as those illustrated in FIGS. 1 to 5 and are denoted by the same reference numerals, redundant descriptions thereof may be omitted.

Each of the plurality of first die pushers 220 may include a die contact portion 221 and a die pusher actuator 225. The die contact portion 221 may be in contact with a first die pusher pressing surface 158 of the die 150A.

The die pusher actuator 225 may provide a driving force to press the die contact portion 221 toward the die 150A. The die pusher actuator 225 may include, for example, one selected from the group consisting of an electric motor, a pneumatic cylinder, and a hydraulic cylinder.

Each of the plurality of first punch pushers 260 may include a punch contact portion 261 and a punch pusher actuator 265. The punch contact portion 261 may be in contact with a contact surface 179 of the punch 170.

The punch pusher actuator 265 may provide a driving force to press the punch contact portion 261 toward the punch 170. The punch pusher actuator 265 may include, for example, one selected from the group consisting of an electric motor, a pneumatic cylinder, and a hydraulic cylinder.

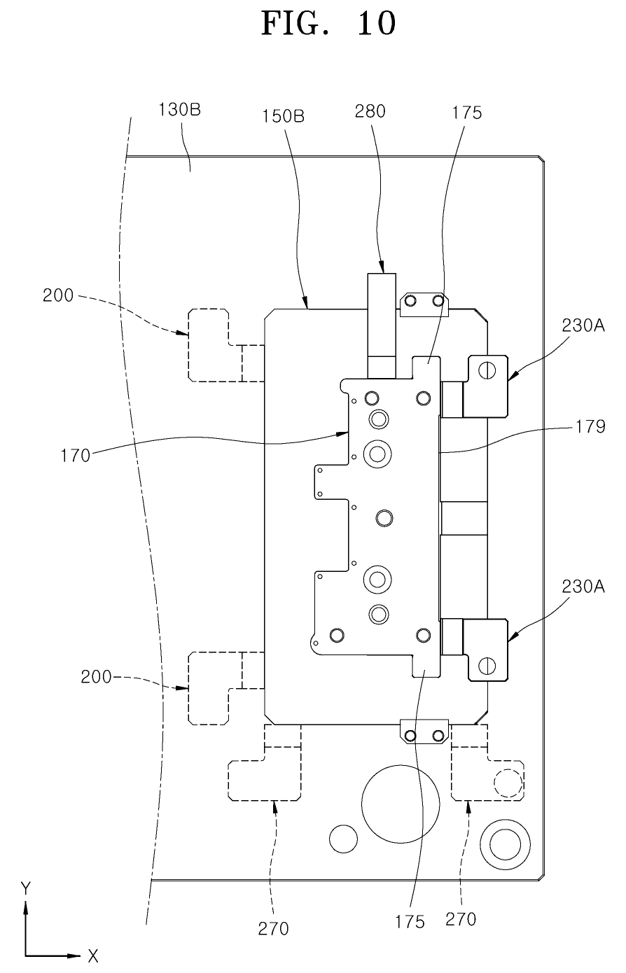

FIG. 10 is a plan view illustrating a die plate, a die, a punch, a first die pusher, a second die pusher, a first punch pusher, and a second punch pusher of an electrode shearing apparatus according to another embodiment of the present disclosure.

Referring to FIGS. 1 to 5 and 10, the electrode shearing apparatus according to another embodiment of the present disclosure may include a die 150B, a punch 170, a die plate 130B, a plurality of first die pushers 200, and a plurality of first punch pushers 230A, as in the electrode shearing apparatus 100 according to the previously described embodiment of the present disclosure.

The die 150B supports the electrode 10 of a secondary battery. The punch 170 cuts, by a shearing force, a part of the electrode 10 that is not supported by the die 150B. The die 150B may be mounted on the die plate 130B.

The first die pusher 200 presses the die 150B in a direction opposite to a direction in which a clearance between the die 150B and the punch 170 is increased. The first punch pusher 230A presses the punch 170 in the direction opposite to the direction in which the clearance between the die 150B and the punch 170 is increased.

The first die pusher 200 presses the die 150B in a direction parallel to the width direction of the electrode 10, and the first punch pusher 230A may also press the punch 170 in the direction parallel to the width direction of the electrode 10. For example, the direction parallel to the width direction of the electrode 10 may be the first direction.

The pressing direction of the first die pusher 200 and the pressing direction of the first punch pusher 230A may be opposite to each other. For example, the pressing direction of the first die pusher 200 may be the positive (+) X-axis direction, and the pressing direction of the first punch pusher 230A may be the negative (-) X-axis direction.

The first die pusher 200 and the first punch pusher 230A may be the same as those illustrated in FIGS. 2 to 6 and 8 and are denoted by the same reference numerals, and redundant descriptions thereof may be omitted.

The electrode shearing apparatus according to the present embodiment of the present disclosure may further include a second die pusher 270 and a second punch pusher 280. The second die pusher 270 may press the die 150B in a direction parallel to a length direction of the electrode 10. A plurality of second die pushers 270 may be provided to be spaced apart from each other. The plurality of second die pushers 270 may be inserted into and mounted in second die pusher mounting through-holes formed in the die plate 130B. Like the first die pusher 200, the second die pusher 270 may include a die pusher housing, a pusher pin, a die contact portion, and an elastic member.

The second punch pusher 280 may press the punch 170 in a direction parallel to the length direction of the electrode 10 and opposite to a direction in which the second die pusher 270 presses the die 150B. For example, the second die pusher 270 may press the die 150B in a positive (+) Y-axis direction, and the second punch pusher 280 may press the punch 170 in a negative (-) Y-axis direction. In an embodiment, like the first punch pusher 230A, the second punch pusher 280 may include a punch pusher housing, a pusher pin, a punch contact portion, and an elastic member.

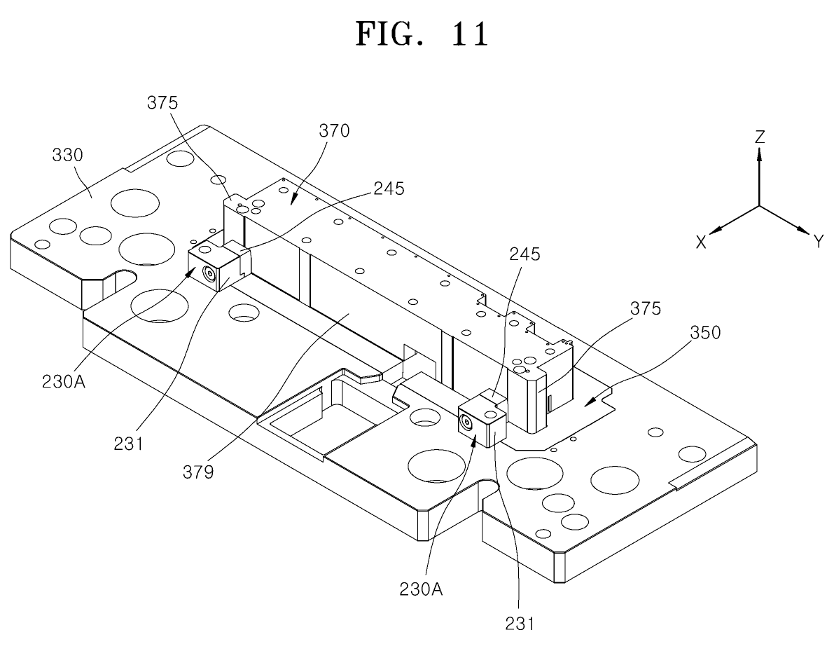

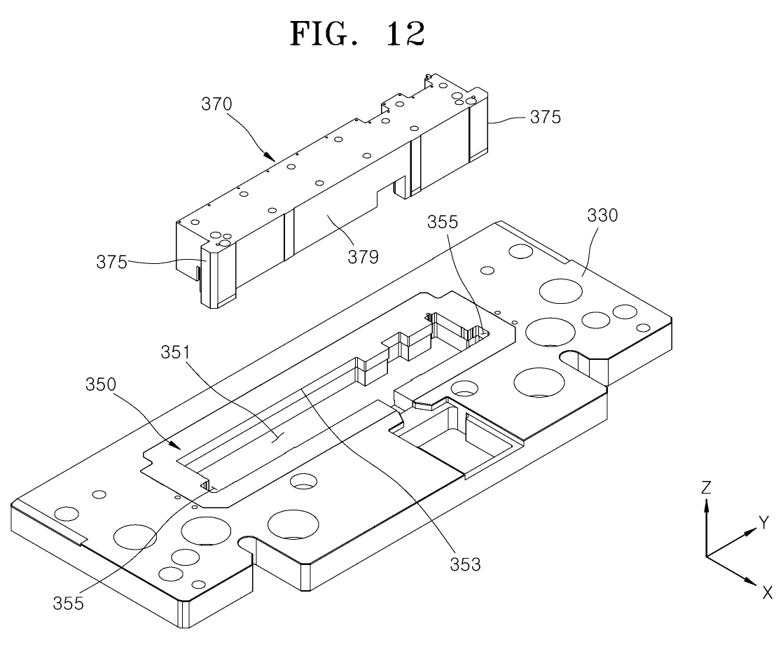

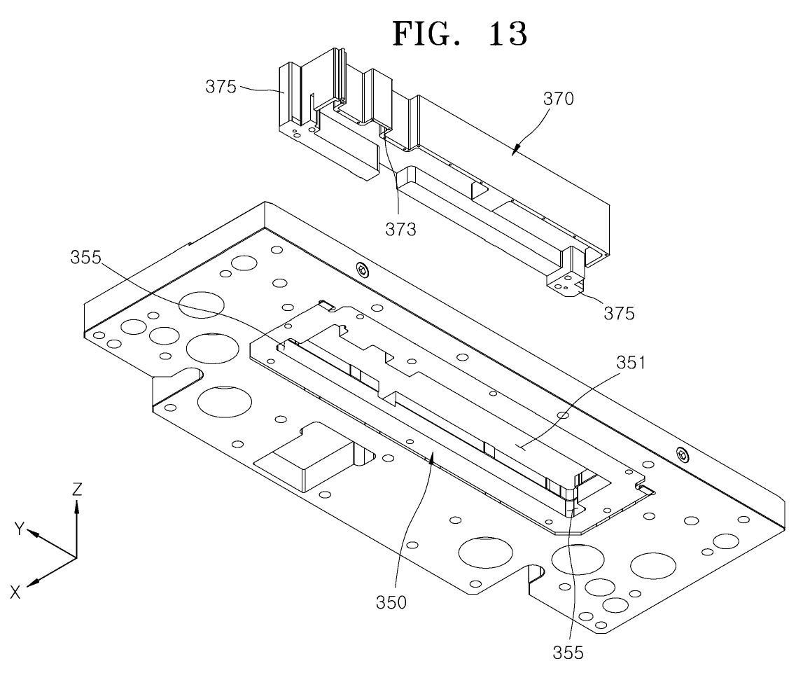

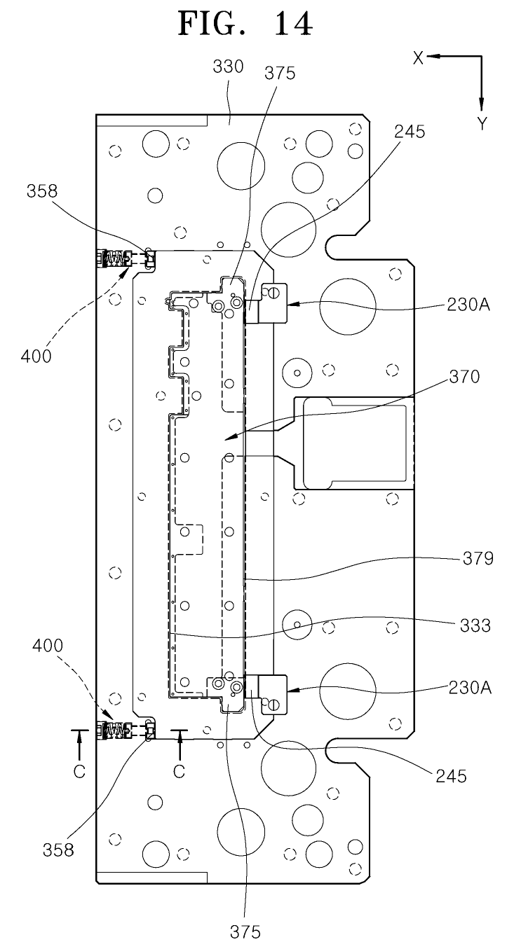

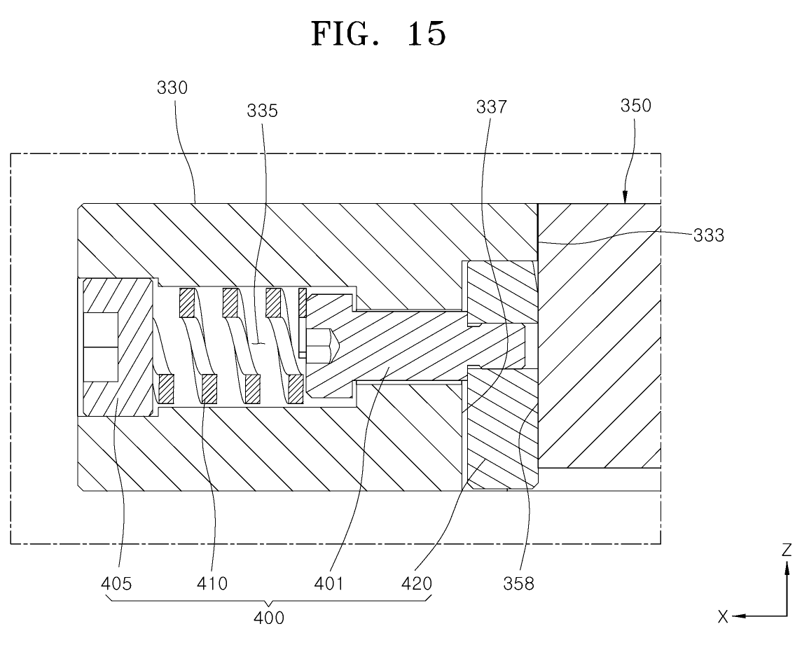

FIG. 11 is a perspective view illustrating a die plate, a die, a punch, a first die pusher, and a first punch pusher of an electrode shearing apparatus according to another embodiment of the present disclosure; FIG. 12 is an exploded perspective view of the die plate, the die, and the punch among components of FIG. 11, as viewed from above; FIG. 13 is an exploded perspective view of the die plate, the die, and the punch among the components of FIG. 11, as viewed from below; FIG. 14 is a plan view of components of FIG. 11; and FIG. 15 is a cross-sectional view of the first die pusher of FIG. 14, taken along the line C-C.

Referring to FIGS. 1 and 11 to 15, the electrode shearing apparatus according to another embodiment of the present disclosure may include a die 350, a punch 370, a die plate 330, a plurality of first die pushers 400, and a plurality of first punch pushers 230A, as in the electrode shearing apparatus 100 according to the previously described embodiment of the present disclosure.

The die 350 supports the electrode 10 of a secondary battery. The punch 370 cuts, by a shearing force, a part of the electrode 10 that is not supported by the die 350.

The die 350 may be mounted on the die plate 330. The die plate 330 may include a die mounting through-hole 333 into which the die 350 is inserted and mounted.

The punch 370 may include an edge 373 that cuts the electrode 10. The edge 373 of the punch 370 may be formed at a lower end portion of the punch 370 in the third direction.

The die 350 may include a punch through-hole 351 and an edge 353. The edge 373 of the punch 370 may be inserted into the punch through-hole 351 when the electrode 10 is cut. A scrap (not shown) separated from the electrode 10 by the shearing process may be discharged to the outside of the electrode shearing apparatus through the punch through-hole 351.

The edge 353 of the die 350 may be formed at a position spaced apart from the edge 373 of the punch 370 by a clearance (e.g., a predetermined clearance) in the first and second directions. The edge 353 of the die 350 may be formed at an upper end portion of the die 350 in the third direction.

While the electrode 10 is supported on upper surfaces of the die plate 330 and the die 350 and proceeds in the second direction, the electrode 10 may be sheared as a punch holder 110 and the punch 370 supported by the punch holder 110 reciprocate in the third direction with respect to the die 350. For example, the punch holder 110 and the punch 370 may reciprocate up and down above a die holder 101 in a direction toward the die holder 101 and in an opposite direction.

The punch 370 may include a guide rail 375 protruding further in a direction toward the die 350 than the edge 373. In an embodiment, a pair of guide rails 375 may be provided. The pair of guide rails 375 may be respectively located at both, or opposite, side end portions of the punch 370 in the second direction and may protrude in directions opposite to each other in the second direction.

The pair of guide rails 375 may extend in the third direction. The pair of guide rails 375 may protrude further than the edge 373 of the punch 370 in the direction toward the die 350. Here, the direction toward the die 350 may be, for example, the third direction, that is, the negative (-) Z-axis direction.

The die 350 may further include a guide groove 355 into which the guide rail 375 is inserted. A pair of guide grooves 355 may be provided in one-to-one correspondence with the guide rails 375. The pair of guide grooves 355 may be a part or region of the punch through-hole 351. In an embodiment, while the punch 370 reciprocates in the third direction with respect to the die 350, at least a part of each guide rail 375 may always be inserted into the corresponding guide groove 355.

As shown in FIG. 13, a lower end portion of the guide rail 375 protrudes further toward the die 350 than the edge 373 of the punch 370, and even when the edge 373 of the punch 370 is positioned higher than an upper surface of the die 350 during the reciprocating movement, that is, a vertical movement of the punch 370, the lower end portion of the guide rail 375 may be inserted into the guide groove 355. When the punch 370 reciprocates in the third direction with respect to the die 350, the guide rail 375 may slide in the third direction while remaining in contact with an inner surface of the guide groove 355.

The plurality of first die pushers 400 press the die 350 in a direction opposite to a direction in which a clearance between the die 350 and the punch 370 is increased. The plurality of first punch pushers 230A press the punch 370 in the direction opposite to the direction in which the clearance between the die 350 and the punch 370 is increased.

The first die pushers 400 press the die 350 in a direction parallel to the width direction of the electrode 10, and the first punch pushers 230A may also press the punch 370 in the direction parallel to the width direction of the electrode 10. For example, the direction parallel to the width direction of the electrode 10 may be the first direction.

The pressing direction of the first die pusher 400 and the pressing direction of the first punch pusher 230A may be opposite to each other. For example, the pressing direction of the first die pusher 400 may be the positive (+) X-axis direction, and the pressing direction of the first punch pusher 230A may be the negative (-) X-axis direction.

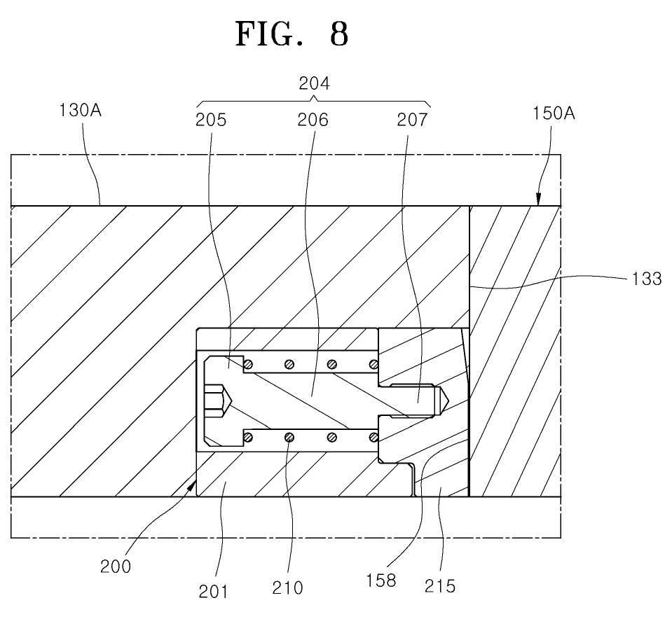

Each of the first die pushers 400 may include a die contact portion 420, a pusher pin 401, a plug 405, and an elastic member 410. The first die pusher 400 illustrated in FIG. 15 may not include a die pusher housing, unlike the first die pusher 200 illustrated in FIG. 8.

The die contact portion 420 may be inserted into the die plate 330 and may be in contact with the die 350. The die 350 may include a first die pusher pressing surface 358 that is in contact with the die contact portion 420. The die plate 330 may include a die contact portion insertion groove 337 into which the die contact portion 420 is inserted. The die contact portion 420 may be inserted into the die contact portion insertion groove 337 of the die plate 330 in a positive (+) Z-axis direction from a lower surface of the die plate 330.

The die plate 330 may further include a pusher pin insertion groove 335 into which the pusher pin 401 is inserted. The pusher pin insertion groove 335 may be connected to the die contact portion insertion groove 337.

The pusher pin 401 may be inserted into the pusher pin insertion groove 335 of the die plate 330 in the negative (-) X-axis direction from a side surface of the die plate 330. The pusher pin 401 may include a side end portion coupled to the die contact portion 420.

The plug 405 is inserted into and fixed to the pusher pin insertion groove 335 of the die plate 330. In the pusher pin insertion groove 335, the plug 405 may be spaced apart from another side end portion of the pusher pin 401.

The elastic member 410 may elastically press the die 350. The elastic member 410 may be inserted into the pusher pin insertion groove 335 after the pusher pin 401 is inserted and before the plug 405 is inserted. The elastic member 410 may be, for example, a coil spring.

The elastic member 410 may include a side end portion supported by the plug 405 and another side end portion in elastic contact with the pusher pin 401 to elastically press the pusher pin 401 and the die contact portion 420 toward the die 350.

The first punch pusher 230A may be the same as that illustrated in FIGS. 2 to 6 and is denoted by the same reference numeral, and a redundant description thereof may be omitted. The first punch pusher 230A may be supported on the upper surface of the die plate 330 or the upper surface of the die 350. In an embodiment, a punch pusher housing 231 of the first punch pusher 230A may be coupled to the upper surface of the die plate 330. In an embodiment, the punch pusher housing 231 may be coupled to the upper surface of the die 350.

According to embodiments of the present disclosure, during an electrode notching operation, a die pusher and a punch pusher respectively press a die and a punch such that a clearance between the die and the punch is prevented or substantially prevented from being increased. Accordingly, the clearance between the die and the punch can be maintained constant (constant or substantially constant), the quality of the electrode notching operation can be improved, a defect rate of the electrode can be reduced, and damage to the die and the punch can be prevented or substantially prevented.

However, aspects and effects obtainable through the present disclosure are not limited to the above aspects and effects, and other aspects and technical effects that are not mentioned will be clearly understood by those skilled in the art from the description of the present disclosure.

While the present disclosure has been described with reference to some embodiments shown in the drawings, these embodiments are merely illustrative and it is to be understood that various modifications and equivalent other embodiments can be derived by those skilled in the art on the basis of the embodiments.

Therefore, the technical scope of the present disclosure should be defined by the claims.

What is claimed is:

1. An electrode shearing apparatus comprising:
a die configured to support an electrode;
a punch configured to cut, by a shearing force, a part of the electrode that is not supported by the die;
a first die pusher configured to press the die in a direction opposite to a direction in which a clearance between the die and the punch is increased; and
a first punch pusher configured to press the punch in the direction opposite to the direction in which the clearance between the die and the punch is increased.

2. The electrode shearing apparatus as claimed in claim 1, wherein the punch comprises an edge configured to cut the electrode, and a guide rail protruding further than the edge in a direction toward the die.

3. The electrode shearing apparatus as claimed in claim 2, wherein the die includes a punch through-hole into which the edge is inserted when the electrode is cut, and a guide groove into which the guide rail is inserted, and
at least a part of the guide rail is always inserted in the guide groove while the punch reciprocates with respect to the die.

4. The electrode shearing apparatus as claimed in claim 3, wherein the guide rail and the guide groove are positioned so as not to overlap the electrode.

5. The electrode shearing apparatus as claimed in claim 1, wherein the first die pusher is positioned to overlap the electrode, and
the first punch pusher is positioned so as not to overlap the electrode.

6. The electrode shearing apparatus as claimed in claim 1, further comprising a die plate into which the die is inserted and on which the first die pusher is coupled and supported.

7. The electrode shearing apparatus as claimed in claim 6, wherein the first die pusher comprises an elastic member configured to elastically press the die.

8. The electrode shearing apparatus as claimed in claim 7, wherein the first die pusher further comprises:
a die pusher housing coupled to the die plate;
a pusher pin comprising a side coupled to the die pusher housing and extending toward the die; and
a die contact portion coupled to the pusher pin and in contact with the die, and
the pusher pin is inserted into the elastic member, and the elastic member comprises a side end portion supported by the pusher pin and another side end portion in elastic contact with the die contact portion to elastically press the die contact portion toward the die.

9. The electrode shearing apparatus as claimed in claim 7, wherein the first die pusher further comprises:
a die contact portion inserted into the die plate and in contact with the die;
a pusher pin inserted into the die plate and comprising a side end portion coupled to the die contact portion; and
a plug inserted into and fixed to the die plate and spaced apart from another side end portion of the pusher pin, and
the elastic member is inserted into the die plate and comprises a side end portion supported by the plug and another side end portion in elastic contact with the pusher pin to elastically press the pusher pin and the die contact portion toward the die.

10. The electrode shearing apparatus as claimed in claim 1, wherein the first die pusher comprises:
a die contact portion in contact with the die; and
a die pusher actuator configured to provide a driving force to press the die contact portion toward the die, and
the die pusher actuator comprises one selected from the group consisting of an electric motor, a pneumatic cylinder, and a hydraulic cylinder.

11. The electrode shearing apparatus as claimed in claim 1, wherein the first punch pusher comprises:
a punch contact portion in contact with the punch; and
an elastic member configured to elastically press the punch contact portion toward the punch.

12. The electrode shearing apparatus as claimed in claim 11, wherein the punch contact portion is always in contact with the punch while the punch reciprocates with respect to the die.

13. The electrode shearing apparatus as claimed in claim 12, wherein the punch contact portion comprises polytetrafluoroethylene.

14. The electrode shearing apparatus as claimed in claim 12, wherein the punch contact portion comprises a roller that rotates by contact with the punch.

15. The electrode shearing apparatus as claimed in claim 1, wherein the first punch pusher comprises:
a punch contact portion in contact with the punch; and
a punch pusher actuator configured to provide a driving force to press the punch contact portion toward the punch, and
the punch pusher actuator comprises one selected from the group consisting of an electric motor, a pneumatic cylinder, and a hydraulic cylinder.

16. The electrode shearing apparatus as claimed in claim 1, further comprising a die plate into which the die is inserted and on which the first punch pusher is coupled and supported.

17. The electrode shearing apparatus as claimed in claim 1, wherein a pressing direction of the first die pusher and a pressing direction of the first punch pusher are opposite to each other.

18. The electrode shearing apparatus as claimed in claim 17, wherein the first die pusher presses the die in a direction parallel to a width direction of the electrode, and
the first punch pusher presses the punch in the direction parallel to the width direction of the electrode.

19. The electrode shearing apparatus as claimed in claim 18, further comprising a second die pusher configured to press the die in a direction parallel to a length direction of the electrode.

20. The electrode shearing apparatus as claimed in claim 19, further comprising a second punch pusher configured to press the punch in the direction parallel to the length direction of the electrode and opposite to the direction in which the second die pusher presses the die.
